(19) United States
(12) Patent Application Publication
(10) Pub. No.: US 2016/0051921 A1
(43) Pub. Date: Feb. 25, 2016

(54) APPARATUS FOR COLLECTING INDUSTRIAL WASTE

(71) Applicant: J CON CO., LTD., Ulsan (KR)

(72) Inventor: Woo Keun JIN, Ulsan (KR)

(73) Assignee: J Con Co., Ltd., Ulsan (KR)

(21) Appl. No.: 14/780,868

(22) PCT Filed: Apr. 1, 2014
(86) PCT No.: PCT/KR2014/002774

§ 371 Date: Sep. 28, 2015

(30) Foreign Application Priority Data
May 8, 2013 (KR) 10-2013-0051840
Nov. 11, 2013 (KR) 10-2013-0136415

(51) Int. Cl. B01D 45/02

(52) U.S. Cl. CPC B01D 45/02

(57) ABSTRACT

An apparatus for collecting industrial waste includes a separator (20) for separating dust from the waste sucked up by vacuum pressure; an upper hopper (30) filled with the waste falling down from the separator (20); a first valve (40) including a pair of semicircular valve plates (41) configured to open or close a lower end of the upper hopper (30), and a cylinder (42) configured to operate the semicircular valve plates (41); a lower hopper (50) having an upper end connected to a lower portion of the upper hopper (40) and an inner volume greater than an inner volume of the upper hopper (40); a second valve (60) having an upper end coupled to a lower end of the lower hopper (50), in which a diameter of the lower hopper (50) is reduced, and configured to rotate an internal butterfly valve (62) according to an operation of a handle (63) provided at one side of the second valve, such that an amount of waste discharged from the lower hopper (50) is controlled and restricted, wherein the second valve (60) has a flange tube shape; and an outlet nozzle (70) having an upper end rotatably connected to a lower end of the second valve (60) and a lower end extending to be close to upper ends of a plurality of drums D loaded on a palette P at a same radius. Therefore, waste can be safely collected by previously preventing waste from being scattered to an outside and from being naturally ignited.

### BACKGROUND

The present invention relates to an apparatus for collecting industrial waste, and more particularly, to an apparatus for collecting industrial waste, which is capable of previously preventing environmental pollution and spontaneous ignition from occurring due to the scattering of waste by prohibiting the waste from making contact with external air while collecting the waste, and being operated continuously without cease to provide more improved collection efficiency while improving working efficiency by safely collecting the waste into a waste collection receptacle.

In general, very various kinds of industrial waste is residual after performing a specific process as various catalysts used to refine crude oil and the quantity of generated waste is large, so that each nation has trouble treating the industrial waste.

Since it is very inappropriate to dispose waste as it is, after the waste is conventionally collected in the working field, the collected waste is buried in a specific area or reprocessed for reuse.

However, the waste collection in a working field is performed through a separated waste collection apparatus.

A typical example of the waste collection apparatus is disclosed in Korean Patent No. 0883973 (issued on Feb. 10, 2009, entitled “Apparatus for separating continuously and automatically waste catalyst” According to the prior art, the waste catalysts are collected in a collector by using vacuum pressure. The dust lighter than air is discharged and collected through a separated path by using vacuum pressure. When a predetermined quantity of waste catalysts heavier than air are filled, the waste catalysts are automatically provided from the separator to a waste collection receptacle through a hopper disposed below the separator, so that the waste collection receptacle is filled with a constant amount of waste catalysts.

However, according to the separating apparatus of the prior art, the dust generated during the process is scattered to an outside, so that serious environment pollution occurs. In addition, some waste catalysts may spontaneously ignite when they make contact with external air, thereby causing fire.

### SUMMARY OF THE INVENTION

To solve the problems described above, an object of the present invention is to provide an apparatus for collecting industrial waste, which is capable of perfectly preventing the danger of scattering dust to an outside and ignition during a process of collecting industrial waste, so that working environment is improved.

Another object of the present invention is to provide an apparatus for collecting industrial waste, which is capable of allowing an end of a nozzle for discharging collected waste to be formed most closely to upper ends of a plurality of waste drums by providing the end of the nozzle and the waste drums at the same radius and capable of allowing waste to be collected safely and continuously into the waste drums while rotating manually and easily the nozzle.

Still another object of the present invention is to provide an apparatus for collecting industrial waste, which is capable of giving sufficient time to discharge industrial waste through a nozzle by more increasing capacities of upper and lower hoppers, so that the work may be mostly prevented from being delayed due to the exchanging of a waste drum.

Still another object of the present invention is to provide an apparatus for collecting industrial waste, which is capable of easily confirming whether a semicircular valve plate, which intermits the movement of waste to a lower hopper, is opened, so that the apparatus may be more safely maintained.

To achieve the above objects of the present invention, there is provided an apparatus for collecting industrial waste, which includes: a separator configured to discharge dust through a vacuum pipe and to allow waste substances heavier than air to fall down, wherein the dust and the waste are included in waste sucked up by vacuum pressure; an upper hopper filled with the waste falling down from the separator; a first valve including a pair of semicircular valve plates configured to open or close a lower end of the upper hopper, and a cylinder configured to operate the semicircular valve plates; a lower hopper having an upper end connected to a lower portion of the upper hopper and an inner volume greater than an inner volume of the upper hopper; a second valve having an upper end coupled to a lower end of the lower hopper, in which a diameter of the lower hopper is reduced, and configured to rotate an internal butterfly valve according to an operation of a handle provided at one side of the second valve, such that an amount of waste discharged from the lower hopper is controlled and restricted, wherein the second valve has a flange tube shape; and an outlet nozzle having an upper end rotatably connected to a lower end of the second valve and a lower end extending to be close to upper ends of a plurality of drums loaded on a palette at a same radius.

According to the present invention, while the apparatus for collecting industrial waste separates the dust lighter than air from the waste, danger of environmental pollution and ignition due to the scattering of waste can be prevented from occurring by completely prohibiting the waste from making contact with external air until the waste is collected into the waste drum.

In addition, the storage capacity of the lower hopper is greatly increased, so that the waste collection into the lower hopper can be continuously performed even through the waste drum is exchanged, thereby providing more fast workability.

Specifically, nitrogen gas is supplied to the separator and the upper and lower hoppers in which the moving space of waste is formed, so that spontaneous ignition can be previously prevented from occurring.

As described above, since environmental pollution and spontaneous ignition are prevented from occurring, the working environment can be always maintained in a clean state and a worker can safely work.

### BRIEF DESCRIPTION OF DRAWINGS

FIG. 1 is a front view illustrating an apparatus for collecting industrial waste according to the present invention.

FIG. 2 is a sectional view illustrating a separator of an apparatus for collecting industrial waste according to the present invention.

FIG. 3 is a sectional view illustrating a part of a first valve of an apparatus for collecting industrial waste according to the present invention.

FIG. 4 is an enlarged view illustrating a configuration of confirming an open or close state of a semicircular valve plate of the first valve according to the present invention.

FIG. 5 is a perspective view illustrating a second valve of an apparatus for collecting industrial waste according to the present invention.

FIG. 6 is a sectional view illustrating a configuration of coupling a second valve to an outlet nozzle of an apparatus for collecting industrial waste according to the present invention.

FIG. 7 is an enlarged view illustrating a rotation part of an outlet nozzle of an apparatus for collecting industrial waste according to the present invention.

FIG. 8 is a side view illustrating a palette transferring unit according to the present invention.

FIG. 9 is a side sectional view illustrating a state that waste is introduced into a separator of an apparatus for collecting industrial waste according to the present invention.

FIG. 10 is a sectional view illustrating a state that waste is transferred from the upper hopper to the lower hopper through the first valve according to the present invention.

FIG. 11 is a half-sectional perspective view showing an operating structure of the second valve according to the present invention.

FIG. 12 is a plan view illustrating a state that waste is continuously supplied to a waste drum by using an outlet nozzle according to the present invention.

FIG. 13 is a view showing a configuration of connecting an outlet nozzle to a waste drum by using a vinyl sack according to the present invention.

### DETAILED DESCRIPTION OF THE INVENTION

Hereinafter, a preferable embodiment according to the present invention will be described in more detail with reference to accompanying drawings.

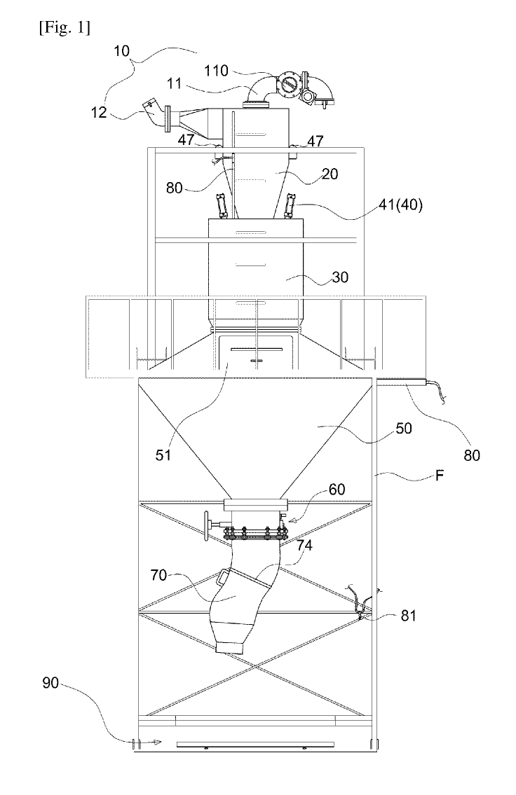

FIG. 1 is a front view illustrating an apparatus for collecting industrial waste according to the present invention.

As shown, an apparatus for collecting industrial waste according to the present invention includes a vacuum pressure generating unit 10, a separator 20, an upper hopper 30, a first valve 40, a lower hopper 50, a second valve 60 and an outlet nozzle 70.

The upper hopper 30, the first valve 40, the lower hopper 50, the second valve 60 and the outlet nozzle 70 are vertically connected to each other from the separator 20, which is provided at an upper end side, to constitute a single body.

A fixing frame F covers outsides of them, such that the separator 20, the upper hopper 30, the first valve 40 and a control box (not shown), which are positioned at an upper portion thereof, can be operated and managed.

The vacuum pressure generating unit 10 according to the present invention generates a vacuum pressure to forcibly suck the waste generated from industrial equipment. Only the dust of the sucked waste lighter than air is separated and collected.

That is, the waste is sucked through an inlet pipe 12 by the vacuum pressure and only the dust of the waste lighter than air is separated and collected through a vacuum pipe 11.

The dust collected through a vacuum pipe 11 is divided into pure air and fine dust through a separated process. The pure air is discharged to an outside and a very small amount of fine dust is separately collected to be disposed together with the waste heavier than air.

The vacuum pressure generated from the vacuum pressure generating unit 10 is released by a vacuum release valve 110 provided to the vacuum pipe 11 and electronically operated.

If the waste suction is performed for a predetermined time while the vacuum pressure is generated, the vacuum release valve 110 is automatically operated, so that external air is introduced to release the vacuum pressure.

Even though the vacuum release valve 110 is operated to be open, the vacuum pressure is still generated and the pressure is equal to the atmospheric pressure only by the external air introduced through the vacuum release valve 110.

The vacuum release valve 110 is opened or closed every a constant time set as a period.

The separator 20 according to the present invention is configured to separate the dust lighter than air from the waste sucked through the inlet pipe 12 of the vacuum pressure generating unit 10.

FIG. 2 is a sectional view illustrating a separator of an apparatus for collecting industrial waste according to the present invention. As shown, the inlet pipe 12 is eccentrically connected to one side of an upper portion of the separator 20 and the vacuum pipe 11 is connected to the center of an upper surface of the separator 20.

A buffer pipe 21 in the form of a dual-pipe including inner and outer pipes 210 and 211, which are concentrically disposed with mutually different diameters, is provided in the separator 20.

The inner and outer tubes 210 and 211 of the buffer pipe 21 have upper ends connected to an inner upper surface of the separator 20 and a vertical length of the outer tube 211 is longer than that of the inner tube 210.

A diameter of the separator 20 is gradually reduced downward from a portion having a predetermined height from a lower portion thereof, so that the separator 20 has a funnel shape.

It is more preferable that the outer tube 211 of the buffer pipe 21 is formed at pre

The upper hopper 30 is provided to a lower portion of the separator 20, such that the upper hopper 30 has a volume greater than an inner volume of the separator 20.

The upper hopper 30 is configured to be filled with a predetermined amount of the waste separated by the separator 20.

An upper end of the upper hopper 30 is flange-coupled to the separator 20 while a lower portion of the separator 20, a diameter of which is reduced, is inserted into the upper hopper 30 by a predetermined depth, so that an inside of the upper hopper 30 is completely blocked from an outside.

The waste is introduced from the separator 20 into the upper hopper 30 due to the own weight thereof and the waste filled in the upper hopper 30 is discharged downward through the first valve 30 provided to a lower end of the upper hopper 30.

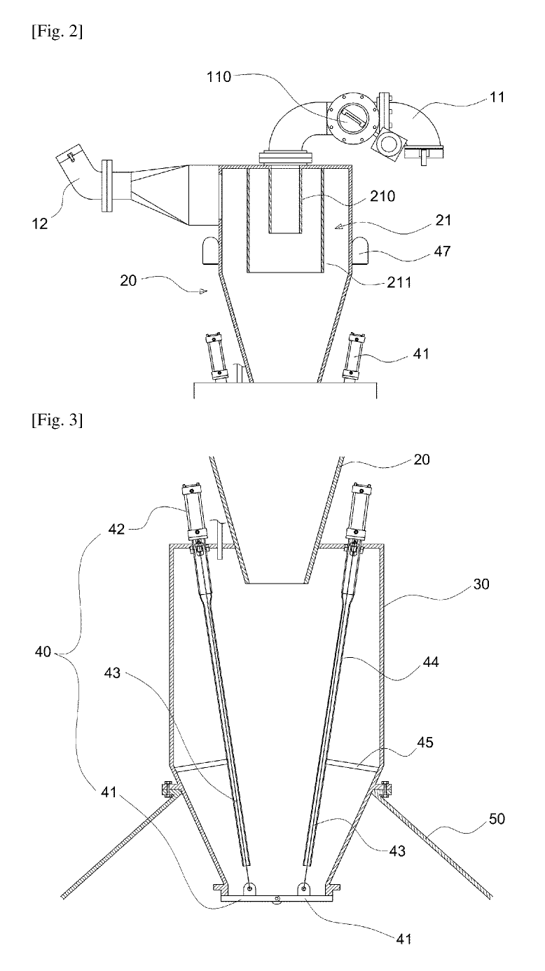

FIG. 3 is a sectional view illustrating a part of a first valve of an apparatus for collecting industrial waste according to the present invention, where the first valve 30 is configured to allow the waste filled in the upper hopper 30 to be discharged every a predetermined time period.

In addition, the first valve 40 includes a pair of semicircular valve plates 41, a pair of cylinders 42 and a pair of cable 43.

The semicircular valve plates 41 are connected to each other to form a circular shape and a hinge shaft is formed between the semicircular valve plates 41, so that the semicircular valve plates 41 are rotatably shaft-supported.

The semicircular valve plates 41 are formed to have a diameter greater than that of the lower end surface of the upper hopper 30.

The cylinder 42 is fixed to both sides of the upper surface of the upper hopper 30 corresponding to the semicircular valve plates 41.

Each of the cylinders 42 has one end inserted into the upper hopper 30 and each piston is reciprocated in the cylinder 42 by a predetermined distance.

The cable 43 connects an end of the piston in the cylinder 42 to an end of the semiconductor valve plate 41.

Thus, according to the first valve 40, when the cylinder 42 is operated to allow the piston to be withdrawn from the cylinder by a predetermined length, the semicircular valve plate 41 connected to the cable 43 is rotated by the own weight thereof. To the contrary, when the cylinder 42 is operated to allow the piston to be pulled into the cylinder, the semicircular valve plate 41 is pulled by the cable 43, so that the lower end of the upper hopper 30 is cut off.

As described above, the first valve 40 is configured to allow the lower end of the upper hopper 30 to be opened or closed according to the operation of the cylinder 42.

Meanwhile, in order to prevent the operation of the cable 43 from being interrupted by the waste in the upper hopper 30, the cable 43 is covered by a guide tube 44. The guide tube 44 is firmly fixed and supported in the upper hopper 30 by a support 45 connected along an inner periphery surface of the upper hopper 30.

In this case, the upper end of the guide tube 44 may be coupled to the cylinder 42 and an upper surface of the upper hopper 30.

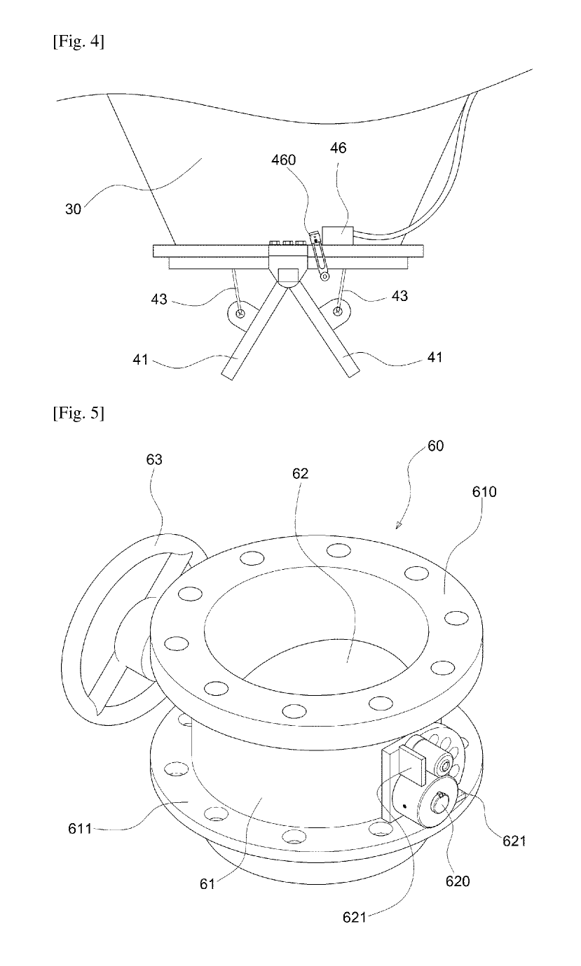

FIG. 4 is an enlarged view illustrating a configuration of confirming an open or close state of a semicircular valve plate of the first valve according to the present invention.

As shown, the pair of semicircular valve plates 41 of the first valve 40 are simultaneously rotated by each cylinder 42 and an open and close sensing switch 46 is provided to one side of the lower end of the upper hopper 30 such that the opening and closing operation of the semicircular valve plates 41 is confirmed from an outside.

The open and close sensing switch operates a switching lever 460 according to the rotation state of the semicircular valve plate 41 such that power is switched on or off. Thus, stack lights 47, which are provided from an outside of the separator 20 to both sides, respectively, are selectively lighted on or off by the open and close sensing switch 46.

For example, when the semicircular valve plates 41 are placed at close positions, the stack lights 47 are lighted off and the stack lights 47 are lighted on when the semicircular valve plates 41 are placed at open positions. Differently from the above, stack lights 47 having mutually different colors may serve as the stack lights 47, so that the stack lights 47 having mutually different colors may be lighted on when the semicircular valve plates 41 are placed at the either open or close positions.

Meanwhile, while it is possible to confirm whether the semicircular valve plates 41 are opened or closed through the stack lights 47, when an error occurs in the opening or closing operation of the semicircular valve plates 41, the error may be confirmed through the stack lights 47 and at the same time, doubly confirmed through a warning sound.

The first valve is opened or closed at a set time. Before the first valve 40 is opened, the vacuum release valve 110 provided to the vacuum pipe 11 is operated to release the vacuum pressure.

That is, when the vacuum pressure is released, the first valve 40 is opened and in addition, the operation of the vacuum release valve 110 pressure is performed at a set time period.

The upper hopper 30 communicates with the lower hopper 50 through the first valve 40.

It is preferable that the lower hopper 50 is formed to have volume twice or greater than that of the upper hopper 30.

The lower hopper 50 is flange-coupled to the tapered periphery surface of the lower portion of the upper hopper 30. More preferably, from the top of the lower hopper 50, the lower end of the upper hopper 30 is inserted into the lower hopper 50 at a predetermined height as shown in FIG. 3.

A diameter of the lower hopper 50 is gradually increased downward beyond the lower end of the upper hopper 30, and then, is gradually deceased downward from the enlarged end of the lower hopper 50.

In this case, the volume of the diameter-decreased portion is greater than that of the diameter-increased portion.

Specifically, it is preferable that the portion having the greatest diameter is located below the height of a periphery surface in a state that the semicircular valve plates 41 of the first valve 40 open the lower end of the upper hopper 30.

Meanwhile, as shown in FIG. 1, a hatch 51 is provided to one side surface of the lower hopper 50 such that the hatch 51 is enabled to be opened or closed, and more preferably, is formed to have a size to enable a worker to enter the inside through the hatch 51.

The hatch 51 is provided to perform an internal work such as trouble shooting of the first valve 40 or an internal cleaning of the lower hopper 50.

Preferably, the lower hopper 50 has capacity capable of receiving waste several times through the operation of the first valve 40 of the upper hopper 30. To this end, it is most preferable that the lower hopper 50 is formed to have volume twice or greater than that of the upper hopper 30.

The end of the lower portion of the lower hopper 50, of which the diameter is gradually decreased, is flange-coupled to the second valve 60.

FIG. 5 is a perspective view illustrating a second valve of an apparatus for collecting industrial waste according to the present invention. The second valve 60 includes a valve body 61 and a butterfly valve 62 and a handle 63.

The valve body 61 of the second valve 60 is formed with a flange tube which has a cylindrical shape and includes flange parts 610 and 611 formed on an upper end and an outer periphery surface at a middle height, respectively, where the flange surface of an upper end side of the valve body 61 is flange-coupled to a lower end of the lower hopper 50.

The butterfly valve 62 having a circular shape is provided in the valve body 61 between the upper and lower flange parts 610 and 611 and has an outer diameter equal to an inner diameter of the valve body 61.

A rotational shaft 20 is integrally coupled to both ends of the outer periphery surface of the butterfly valve 62 in such a manner that rotational shaft 20 may protrude outward from the both ends of the outer periphery surface of the butterfly valve 62 at a predetermined length by horizontally passing through a circumferential surface of the valve body 61.

Thus, the butterfly valve 62 is rotatable about the rotational shaft 620 passing through the valve body 61 to open or close an inside of the valve body 61.

The handle 63 is connected to an end portion protruding toward one side of the valve body 61, so that the butterfly valve 62 is rotated by the operation of rotating the handle 63.

In addition, a pair of stoppers 621 spaced apart from each other by 90° on the outer periphery surface of the valve body 61 are provided to an end of the rotational shaft protruding toward an opposite side of the valve body 61, so that the butterfly valve 62 is rotatable within 90°.

Meanwhile, according to the present invention, an outlet nozzle 70 is connected to the second valve 60, such that the second valve 60 is rotatable horizontally.

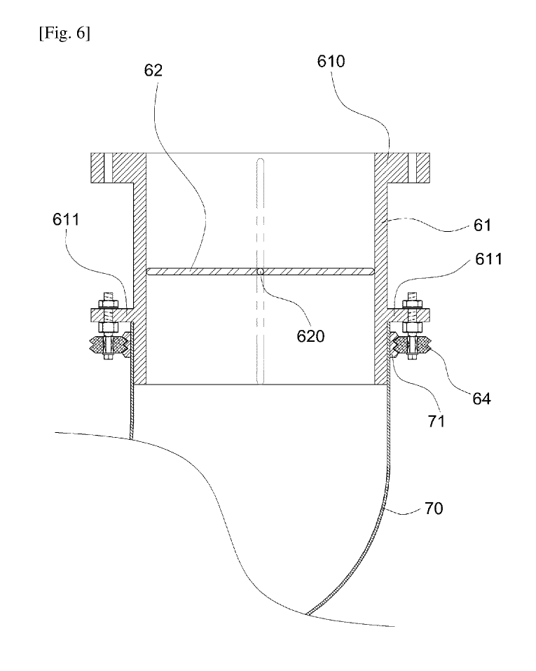

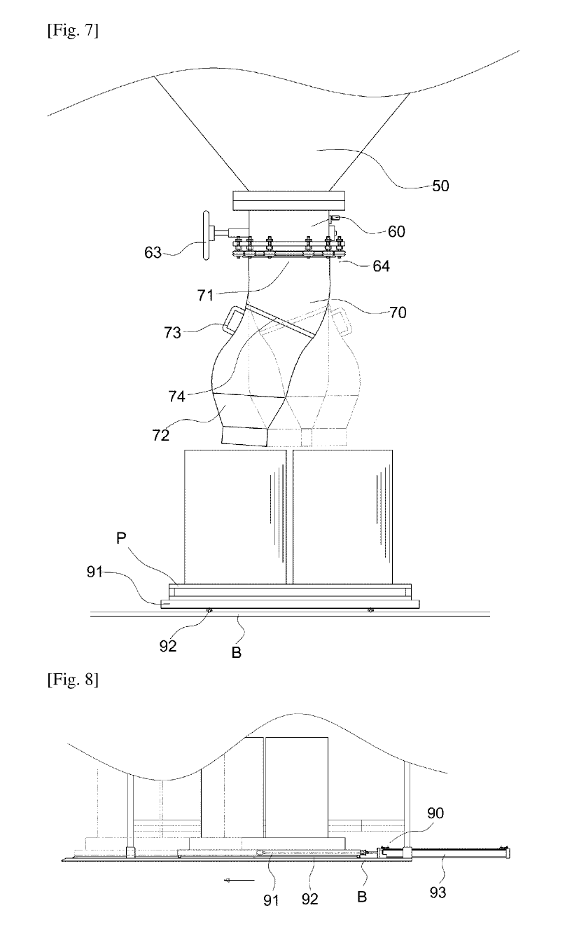

FIG. 6 is a sectional view illustrating a configuration of coupling a second valve to an outlet nozzle of an apparatus for collecting industrial waste according to the present invention. FIG. 7 is an enlarged view illustrating a rotation part of an outlet nozzle of an apparatus for collecting industrial waste according to the present invention.

As shown, the outlet nozzle 70 has an upper end which surrounds the outer periphery surface of the valve body 61 extending toward a lower portion of the lower flange part 611 of the second valve 60.

Meanwhile, a roller bearing 64 and a rail 71 are provided to the lower flange part 611 of the second valve and the outlet nozzle 70, such that the outlet nozzle 70 is not separated downward from the second valve 60 while being rotatable.

That is, the plurality of roller bearings 64 is rotatably shaft-fixed along the periphery surface below the lower flange part 611 of the second valve 60 while being spaced apart from each other by a constant interval, and the rail 71 having a ring shape is coupled to the outer periphery surface of the outlet nozzle 70 facing the roller bearings 64, such that portions of the outer periphery surfaces of the roller bearings 64 are fit-inserted into the rail 71.

Thus, since the roller bearings 64 are rotatably coupled to the rail 71 of the outlet nozzle 70, the outlet nozzle 70 is prevented from being separated downward from the second valve 60 and rotatable on the valve body 61 of the second valve 60 as the roller bearings 64 are rotated along the rail 71.

The lower portion of the outlet nozzle 70 is bent outwardly by a predetermined angle and then, bent downward from an outside again. In addition, an outlet port 72 of the outlet nozzle 70 is placed near an upper end of a waste drum and a diameter of the outlet port 72 is gradually decreased toward the waste drum.

A handle 73 used to manually operate the rotation of the outlet nozzle 70 is formed on an outer periphery surface of an upper side bent toward an outside of the outlet nozzle 70, and a fastening unit such as a rubber band 74 is provided on an outer periphery surface of the outlet nozzle 70 such that an upper end of a vinyl sack covering the waste drum is band-treated on the outer periphery surface below the handle 73.

Specifically, it is more preferable that a noncombustible gas supply tube 80 for supplying noncombustible gas such as nitrogen to prevent ignitable waste from being naturally ignited is connected to the separator 20 and the upper and lower hoppers 30 and 50 of the present invention.

The noncombustible gas is supplied from a storage receptacle and supplied selectively and simultaneously to the separator 20 and the upper and lower hoppers 30 and 50 through the manual operation of a noncombustible gas supply control lever 81 by a worker.

Meanwhile, four waste drums are conventionally grouped as one unit and the waste drums for collecting waste are transferred in units of palette. A palette transferring unit 90 is provided to transfer a palette P.

FIG. 8 is a side view illustrating a palette transferring unit according to the present invention.

The palette transferring unit 90 includes a transfer plate 91 on which the palette P is safely placed, a guide rail 92 provided to both sides of an upper surface of a base plate B to enable the transfer plate 91 to move forward or backward, and a transfer cylinder 93 fixed to one side of the base plate B to reciprocate the transfer plate 91 within a predetermined distance.

The transfer cylinder 93 is operated manually by a worker.

Examining in more detail a process of collecting waste through an apparatus for collecting industrial waste according to the configuration described above, the present invention is operated with the vacuum pressure generated by driving the vacuum pressure generating unit 10.

When waste is generated from industrial equipment, the waste is forcibly sucked by the vacuum pressure through the inlet pipe 12.

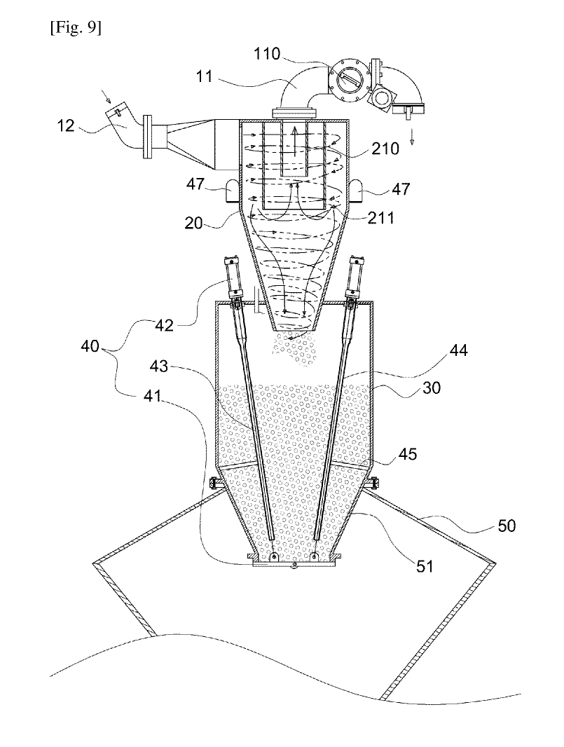

As shown in FIG. 9, the waste sucked through the inlet pipe 12 is supplied to the separator 20.

The waste introduced into the separator 20 moves downwardly while causing a whirlwind between inner periphery surface of the separator 20 and an outer periphery surface of the outer tube 211.

That is, since the vacuum pressure operates on an inside of the separator 20 through the vacuum pipe 11 and the inner tube 210 of the separator 20, the waste introduced into the separator 20 through the inlet pipe 12 moves toward the lower end of the inner tube 210 while causing a whirlwind at an outside of the outer tube 211.

The waste transferred to the lower portion of the separator 20 is introduced into the lower tube 211 having a length longer than the inner tube 210, where dust lighter than air is sucked to the vacuum pipe 11 through the inner tube 210 and most of the waste heavier than air falls down due to its own weight.

The waste transferred downwardly from the separator 20 is collected in the upper hopper 30.

Since the lower end of the upper hopper 30 is closed by the semicircular valve plates 41 of the first valve 40, the waste is collected in the upper hopper 30.

When a predetermined amount of waste is collected in the upper hopper 30, the waste collected in the upper hopper 30 falls to the lower hopper 50 by the driving of the first valve 40.

The first valve 40 interworks with the vacuum release valve 110 conventionally operated on a predetermined period of time and the operation of the first valve 40 is performed for a set time.

Meanwhile, when the semicircular valve plates 41 of the first valve 40 are normally opened and closed, the stack light 47 provided on the outer periphery surface of the separator 20 to be lighted on or off while the open and close sensing switch 46 is switched on/off according to the state of the semicircular valve plates 41, so that the open or close state may be confirmed with the unaided eyes.

However, when the open and close sensing switch 46 is out of order or the semicircular valve plates 41 are not exactly opened or closed, the stack light 47 at an outside is abnormally lighted on or off and immediately, it is automatically ceased to generate the vacuum pressure

That is, when the semicircular valve plates 41 are not so much opened as required at the minimum, or not completely closed at a time point when the lower end of the upper hopper 30 must be tightly closed, it is ceased to generate the vacuum pressure while the stack light 47 is automatically allowed to be abnormally lighted on, so that big accident may be prevented from occurring.

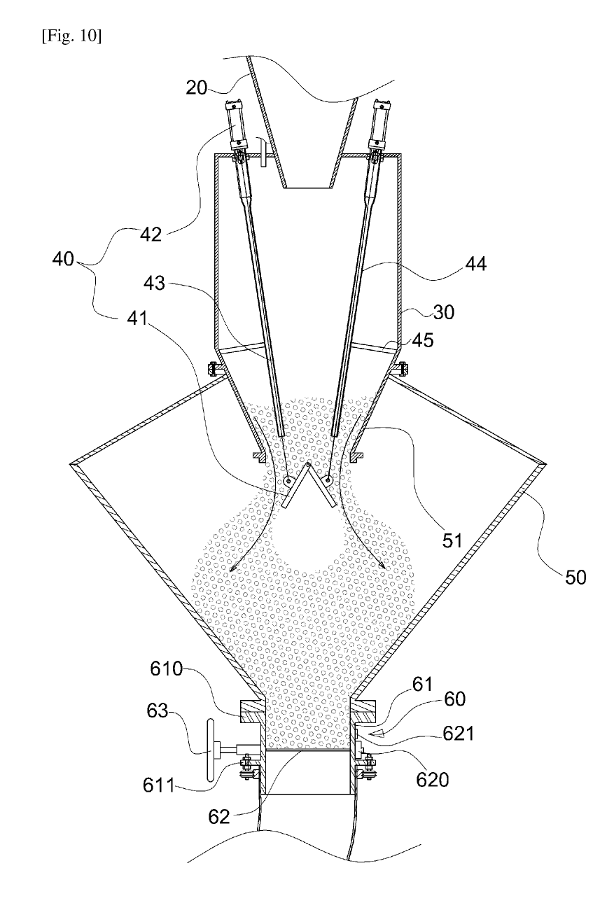

FIG. 10 is a sectional view illustrating a state that waste is transferred from the upper hopper to the lower hopper through the first valve according to the present invention.

As shown, when the cylinder 42 is driven by the first valve 40 to allow the piston to be drawn out from the cylinder 42 in the state that the vacuum pressure is released by driving the vacuum release valve 110, the semicircular valve plates 41, which is connected to an opposite end of the cable 43 connected to one end of the piston, opens the lower end of the upper hopper 30 due to the weight of the waste collected in the upper hopper 30.

While the lower end of the upper hopper 30 is opened, all the waste filled in the upper hopper 30 is supplied to the lower hopper 50. Then, the lower end of the upper hopper 30 is closed by driving the first valve 40 again.

When the lower end of the upper hopper 30 is closed, the vacuum pressure is again generated in the vacuum pipe 12 while the vacuum release valve 120 in an opened state is closed.

Thus, while vacuum pressure is simultaneously formed in the separator 20 and the inlet pipe 11, the waste is again absorbed into the separator 20 through the inlet pipe 11.

Meanwhile, since the lower hopper 50 has inner volume greater than that of the upper hopper 30, even though waste is collected from the upper hopper 30, the lower hopper 50 may collect waste several times.

The waste introduced into the lower hopper 50 is collected into a waste drum through the outlet nozzle 70 when a worker in a working field manually operates the handle 63 of the second valve 60.

That is, although the waste is automatically supplied from the upper hopper 30 to the lower hopper 50 by periodically opening the first valve 40 every constant time periods, the waste in the lower hopper 50 is provided into the waste drum when a worker manually operates the second valve 60.

Meanwhile, the noncombustible gas such as nitrogen may be supplied to the separator 20 and the upper and lower hoppers 30 and 50 through the manual operation of the noncombustible gas supply control lever 81 which allows the supply of noncombustible gas to be intermitted through the manual operation.

Specifically, the noncombustible gas is used when the treated waste has a high natural ignition property.

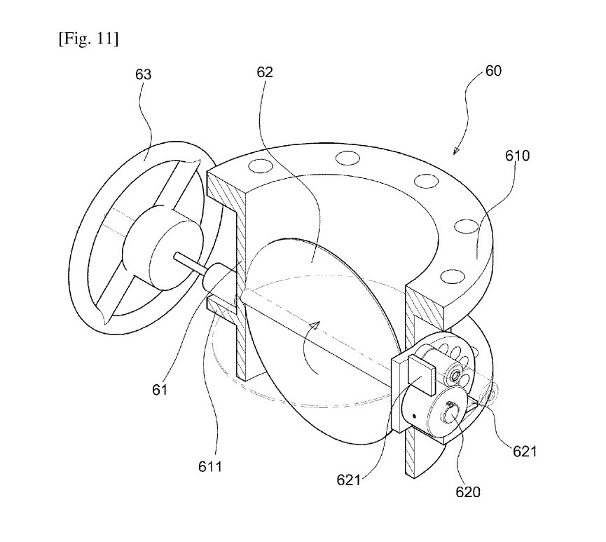

FIG. 11 is a half-sectional perspective view showing an operating structure of the second valve according to the present invention. As shown in FIG. 11, according to the second valve 60 of the present invention, the butterfly valve 62 provided in the valve body 61 may be rotated in the range of 90°.

In other words, when a worker rotates the handle 63 provided to one side of the valve body 61 in the second valve, while the butterfly valve 62 provided in the valve body 61 is rotated, the waste on the butterfly valve 62 falls downward.

Thus, when the rotation angle of the handle 63 is suitably controlled, the amount of waste falling downward through the butterfly valve 62 may be suitably controlled.

However, the rotation angle of the butterfly valve 62 is limited within 90° by the stopper 621 formed on the outer periphery surface of the valve body 61.

The waste falling through the second valve 60 is collected into the waste drum through the tube-shaped outlet nozzle 70.

Since the outlet nozzle 70 is rotatably connected to the valve body 61 of the second valve 60 through the roller bearings 64, the outlet nozzle 70 is controllable to be rotated at various angles based on the upper end connected to the valve body 61 of the outlet nozzle 70.

When a worker pushes the rotation of the outlet nozzle 70 while holding the handle 72, the roller bearings 64 inserted into the rail 71 coupled to the upper end of the outlet nozzle 70 are rotated so that the outlet nozzle 70 is smoothly rotated.

The roller bearings 64 are coupled to the rail 71, so that the outlet nozzle 70 is supported to prevent the outlet nozzle 70 from being separated downward. Since the outlet nozzle 70 minimizes the frictional resistance against the rail 71 when the outlet nozzle 70 is rotated, it is possible to allow the outlet nozzle 70 to be rotated more easily and smoothly.

The rotation of the outlet nozzle 70 allows the position of the outlet port 72 of the outlet nozzle 70 to be changed when a worker holds the handle 73 formed on the outer periphery surface of the upper portion of the outlet nozzle 70 to push or pull the outlet nozzle 70.

In this case, the outlet port 72 is closed to the waste drum as possible to the extent that the outlet port 72 does not make contact with the waste drum while protruding in one side direction based on the upper end connected to the valve body 61 of the outlet nozzle 70, so that the outlet nozzle 70 is prevented from colliding against the waste drum even if the outlet nozzle 70 is rotated.

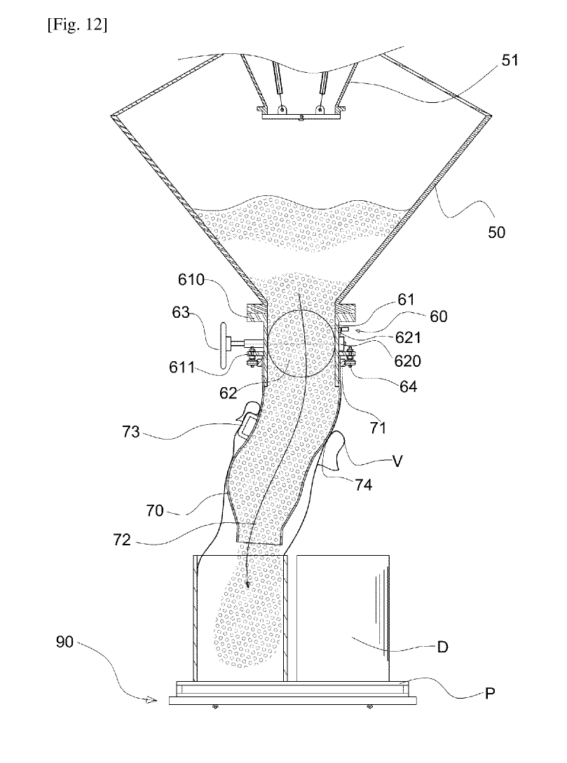

FIG. 12 is a plan view illustrating a state that waste is continuously supplied to the waste drum by using the outlet nozzle according to the present invention.

As shown in FIG. 12, the palette transferring unit 90 is provided below the outlet nozzle 70 to draw the plurality of waste drums D therein or out therefrom.

Since the waste drums D are loaded on the palette P in units of four waste drums, the waste drums D are arranged at 90° with respect to each other.

Thus, the transfer plate 91 is reciprocated along the guide rail 92 fixed to the base plate B within a predetermined distance as the transfer cylinder 93 is driven by a worker, so that the waste drums D supplied below the outlet nozzle 70 are exchanged in units of palettes P.

That is, in the state that the transfer plate 91 is drawn out to an outside to the extent that the transfer plate 91 does not escape from one end of the base plate B by driving the transfer cylinder 93 through a switch operation, the palette P on which four empty drums D are loaded is safely placed by using a fork lift.

In the state that the palette P is safely placed on the transfer plate 91, when the transfer cylinder 93 is again driven through a switch operation, the transfer plate 92 returns to a preset position.

When the transfer plate 91 returns to the original position as described above, the waste drums D on the palette P loaded on the transfer plate 91 are located within a turning radius of the outlet port 72 of the outlet nozzle 70.

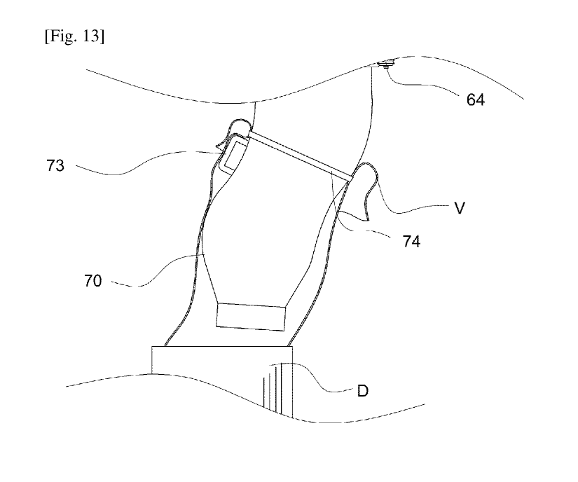

As shown in FIG. 13, since the waste packing vinyl sacks V are inserted into the waste drums D loaded on the palette P, respectively, an upper end of the vinyl sack V is pulled up from the waste drum D closest to the outlet port 72 of the outlet nozzle 70, such that the vinyl sack V partially surrounds a lower portion of the outlet nozzle 70.

When the upper end of the vinyl sack V is fixed by using a rubber band 74 previously prepared at the outer periphery surface of the outlet nozzle 70 after the lower portion of the outlet nozzle 70 is surrounded by the vinyl sack V, the waste output through the outlet port 72 of the outlet nozzle 70 is filled in the waste drum D without making contact with an outside.

As described above, when one waste drum D is filled with waste, the upper portion of the vinyl sack V is fastened to be blocked from an outside.

When one waste drum D is fully filled with waste, a worker operates the handle 63 of the second valve 60 such that waste is not supplied to the outlet nozzle 70 anymore.

When the supply of waste through the outlet port 72 of the outlet nozzle 70 is blocked, the worker rotates the outlet nozzle 70 with the handle 73 again to move the outlet port 72 to an empty waste drum D adjacent thereto.

As described above, the waste drums D are sequentially filled with waste by rotating the outlet nozzle 70 and manipulating the handle 63 of the second valve 60.

When all the waste drums D safely placed on the palette P are filled with waste, a worker drives the transfer cylinder 93 to allow the transfer plate 91 on which the palette P is safely placed to be drawn out to one side of the base plate B. Then, the palette P on the transfer plate 91 is lifted out by using a fork lift and the palette P on which empty waste drums D are safely loaded is safely placed on the transfer plate 91.

Meanwhile, according to the present invention, while the palette P is exchanged, the waste is continuously collected due to the vacuum pressure and the waste induced from the separator 20 and the upper hopper 30 is collected in the lower hopper 50.

When one waste drum D is filled with waste, the upper end of the vinyl sack V covering the lower portion of the outlet nozzle 70 is separated from a fastening unit such as a rubber band 74 in the state that the second valve 60 is temporarily closed, in order to allow the upper end to be fastened at an inner side upper end of the waste drum D, so that the inside of the vinyl sack V is safely sealed.

After one waste drum 90 filled with waste is sealed, the outlet nozzle 70 is rotated such that the outlet port 70 is placed over an empty waste drum D adjacent thereto again.

According to the present invention, the empty waste drums are filled with waste and then sealed by sequentially rotating the outlet nozzle 70 to the empty waste drums D and this work is continuously repeated, so that the waste drums D are exchanged in units of palettes P.

As described above, according to the present invention, while the waste transfers from the separator 10 to the lower hopper 30 and the waste drum D, the waste is perfectly prevented from making contact with external air, so that the dust of waste is perfectly prevented from being scattered, thereby improving the surrounding working environment more pleasantly.

In addition, during working, the visual field of a worker may be finely and stably secured and maintained, so that the workability may be improved and the health of a worker and surrounding residents may be safely kept.

Specifically, it is possible to collect waste always and safely by preventing waste from making contact with external air and supplying noncombustible gas such as nitrogen to fundamentally prevent ignitable waste from being naturally ignited.

In addition, according to the present invention, even while the waste drum D is exchanged or the palette P on which the plurality of waste drums D are loaded is exchanged, the waste is continuously collected into the lower hopper 50 due to the generation of the vacuum pressure, so that the waste collection work can be rapidly performed.

1. An apparatus for collecting industrial waste, the apparatus comprising:
a separator configured to discharge dust through a vacuum pipe and to allow waste substances heavier than air to fall down, wherein the dust and the waste are included in waste sucked up by vacuum pressure;
an upper hopper filled with the waste falling down from the separator;
a first valve including a pair of semicircular valve plates configured to open or close a lower end of the upper hopper, and a cylinder configured to operate the semicircular valve plates;
a lower hopper having an upper end connected to a lower portion of the upper hopper and an inner volume greater than an inner volume of the upper hopper;
a second valve having an upper end coupled to a lower end of the lower hopper, in which a diameter of the lower hopper is reduced, and configured to rotate an internal butterfly valve according to an operation of a handle provided at one side of the second valve, such that an amount of waste discharged from the lower hopper is controlled and restricted, wherein the second valve has a flange tube shape; and
an outlet nozzle having an upper end rotatably connected to a lower end of the second valve and a lower end extending to be close to upper ends of a plurality of drums loaded on a palette at a same radius.

2. The apparatus of claim 1, further comprising an inlet pipe eccentrically connected to one side of an upper portion of the separator, a vacuum pipe connected to a central portion of an upper surface of the separator, and a vacuum release valve provided to the vacuum pipe of the separator.

3. The apparatus of claim 1, further comprising a dual-pipe type buffer pipe provided in the separator, wherein the buffer pipe includes an inner tube which is connected to the vacuum pipe to communicate with the vacuum pipe and has an upper end coupled to an upper surface of the separator, and an outer tube having a diameter larger than a diameter of the inner tube and being concentric with the inner tube.

4. The apparatus of claim 3, wherein the outer tube of the buffer pipe has a length longer than a length of the inner tube, such that a lower end of the outer tube is placed at a position lower than a lower end of the inner tube.

5. The apparatus of claim 1, wherein the first valve includes a pair of semicircular valve plates rotatably supported from a lower end of the upper hopper; and
cylinders provided at both sides of an upper surface of the upper hopper, respectively, and connected to the semicircular valve plates through cables to allow a lower end of the upper hopper to be opened or closed through the semicircular valve plates.

6. The apparatus of claim 1, wherein the cylinders are provided on the upper surface of the upper hopper connected to the separator and interworks with the vacuum release valve periodically operated according to a predetermined time period.

7. The apparatus of claim 1, wherein the lower hopper includes a hatch such that one side surface of the lower hopper is opened or closed.

8. The apparatus of claim 1, wherein the lower hopper has an inner volume twice than a volume of the upper hopper.

9. The apparatus of claim 1, wherein the second valve includes a valve body having a flange tube of a circular shape, the flange tube having flange parts which are formed on an upper end and an outer periphery surface having a middle height of the flange tube, respectively;
a butterfly valve having an outer diameter equal to an inner diameter of the valve body and both outer ends which is coupled integrally to a rotational shaft which is rotatably shaft supported while passing through a periphery surface of the valve body; and
a handle connected to one end of a rotational shaft protruding out of the valve body and rotating the butterfly valve by a rotational manipulation, such that the butterfly valve is opened or closed.

10. The apparatus of claim 9, wherein the rotational shaft has one end to which the handle is shaft-supported and another end protruding from the valve body in an opposite end of the one end, wherein rotations of the ends are limited by a pair of stoppers attached to an outer periphery surface of the valve body.

11. The apparatus of claim 1, wherein the outlet nozzle has an upper end rotatably connected to a lower end of the second valve and a lower end bent downwardly while being bent toward one side, such that an outlet port approaches an upper end of a waste drum.

12. The apparatus of claim 1, wherein the second valve includes a lower flange part and a rail having a ring shape, the lower flange has a plurality of roller bearings which are shaft-fixed and are spaced apart from each other by a predetermined interval along a periphery surface of the lower flange part such that the roller bearings are rotatably shaft-supported, and the rail is coupled to an outer periphery surface of an upper portion of the outlet nozzle facing the roller bearings, such that one side periphery surfaces of the roller bearings are fit-inserted into the rail.

13. The apparatus of claim 1, further comprising a handle which is formed integrally to an outer periphery surface of the outlet nozzle such that the outlet nozzle is easily and manually rotated.

14. The apparatus of claim 1, further comprising fastening unit which is provided on an outer periphery surface of the outlet nozzle such that an upper end of a vinyl sack covering a waste drum is band-treated, wherein the fastening unit includes a rubber band.

15. The apparatus of claim 1, further comprising a noncombustible gas supply tube for supplying noncombustible gas to prevent ignitable waste from being naturally ignited, wherein the noncombustible gas supply tube is connected to the separator and the upper and lower hoppers, and wherein the noncombustible gas includes nitrogen.

16. The apparatus of claim 1, wherein the palette is transferred by a predetermined distance through a palette transferring unit, and wherein the palette transferring unit includes a transfer plate on which the palette is safely placed, a guide rail provided to both sides of an upper surface of a base plate to enable the transfer plate to move forward or backward, and a transfer cylinder fixed to one side of the base plate to reciprocate the transfer plate within a predetermined distance.
